(19) United States
(12) Patent Application Publication
(10) Pub. No.: US 2012/0038317 A1
(43) Pub. Date: Feb. 16, 2012

(54) WIRELESS CHARGING SYSTEM

(75) Inventors: Takashi Miyamoto, Chiba (JP); Yoichi Uramoto, Kanagawa (JP); Kohei Mori, Tokyo (JP); Hirotsugu Wada, Kanagawa (JP); Takaaki Hashiguchi, Tokyo (JP)

(73) Assignee: SONY CORPORATION, Tokyo (JP)

(21) Appl. No.: 13/197,842

(22) Filed: Aug. 4, 2011

(30) Foreign Application Priority Data
Aug. 13, 2010 (JP) 2010-181246

(51) Int. Cl. H02J 7/00

(52) U.S. Cl. 320/108

(57) ABSTRACT

Disclosed herein is a wireless charging system, including: a primary device that includes a power transmitter adapted to transmit power wirelessly; and a secondary device that includes a power receiver adapted to receive power transmitted wirelessly from the power transmitter, wherein the secondary device also includes a sensor adapted to detect any anomaly in the power transmission path between the power transmitter and receiver.

### BACKGROUND

The present disclosure relates to a noncontact power feeding type wireless charging system capable of supplying power in a noncontact (wireless) manner to an electronic device such as a mobile phone that includes a rechargeable battery.

The electromagnetic induction method is known as a means to supply power wirelessly.

On the other hand, recent years have seen attention focused on wireless power feeding and charging systems based on magnetic resonance that relies on the electromagnetic resonance phenomenon.

With the electromagnetic induction type noncontact power feeding method widely used today, it is necessary for the source of power and destination of power (power receiving side) to share a magnetic flux. For efficient power transmission, the source and destination of power are arranged extremely close to each other. Further, coupling alignment is also important.

On the other hand, the noncontact power feeding method based on the electromagnetic resonance phenomenon is advantageous in that it allows for power transmission over a longer distance than the electromagnetic induction method thanks to the principle of the electromagnetic resonance phenomenon, and that the transmission efficiency does not degrade much even with somewhat poor alignment.

It should be noted that the electric field resonance method is another method based on the electromagnetic resonance phenomenon.

With the magnetic resonance type wireless power feeding system, alignment is not necessary, thus achieving a longer power feeding distance.

Incidentally, compact portable electronic devices are carried along more frequently in recent years. These mobile devices (portable devices) each incorporate a secondary battery that is generally charged regularly for use.

In the above wireless power transmission adapted to supply power from a power transmitter to a power receiver, for example, by electromagnetic induction, if a foreign object such as a coin or key capable of generating an eddy current is provided between the power transmitter and receiver during power transmission, this results not only in power loss but also in heating of the foreign object itself.

Therefore, the approach under consideration is to add a temperature sensor to the transmitter so as to measure the temperature as a countermeasure against the heating of the foreign object.

For example, Japanese Patent Laid-Open No. 2003-153457 discloses a noncontact charger intended not only to perform charging in as short a time as possible while at the same time keeping the temperature rise of the charged device to a minimum but also to prevent abnormal temperature rise if a metallic foreign object is provided in the charging section.

Further, Japanese Patent Laid-Open No. 2008-172874 discloses a noncontact charger intended to provide improved safety. This charger does so using a temperature sensing element provided at the optimal position on the noncontact charger and stops the charging immediately in the event of detection of an abnormal temperature rise of the object placed thereon.

It can be said that these countermeasures are designed strictly for the case in which there are one power transmitter and one power receiver.

### SUMMARY

However, recent years have seen increasing demand for a single charger to charge a plurality of devices in a noncontact manner.

What would be necessary in this case is that a plurality of secondary devices, each incorporating a power receiver, can be placed on a primary device incorporating a power transmitter and that power can also be supplied to each of the secondary devices.

If temperature sensors are provided on the primary device configured as described above, it is necessary to know the sizes and locations of all the foreign objects. As a result, an infinite number of temperature sensors would be used.

This could significantly affect the cost, thus making this option far from feasible.

Further, the magnetic lines of force distributed between the power transmitter and receiver may be disturbed by the infinite number of temperature sensors, thus making it highly likely that the efficiency between the power transmitter and receiver (power feeding efficiency) will degrade.

As described above, if there is a foreign object (metal) such as a coin or key between the power transmitter incorporating a primary device and the power receivers each incorporating a secondary device, an eddy current is generated in the foreign object because of its exposure to strong magnetic fields distributed between the power transmitter and receivers.

However, the above-mentioned techniques may lead to higher cost due to a large number of sensors and result in degraded power feeding efficiency although capable of preventing heating of the foreign object caused by temperature rise.

It is desirable to provide a wireless charging system capable of avoiding heating with a minimum number of sensors and moreover performing charging with high efficiency.

A wireless charging system according to a first mode of the present disclosure includes primary and secondary devices. The primary device includes a power transmitter adapted to transmit power wirelessly. The secondary device includes a power receiver adapted to receive power transmitted wirelessly from the power transmitter. The secondary device also includes a sensor adapted to detect any anomaly in the power transmission path between the power transmitter and receiver.

The present disclosure avoids heating with a minimum number of sensors and moreover allows for highly efficient charging.

### BRIEF DESCRIPTION OF THE DRAWINGS

FIG. 1 is a diagram illustrating an overall configuration example of a wireless charging system according to an embodiment of the present disclosure;

FIG. 2 is a block diagram illustrating a basic configuration example of the wireless charging system including a foreign object detector according to the embodiment of the present disclosure;

FIG. 3 is a diagram schematically illustrating an example of the relationship between coils on the power transmitting and receiving sides according to the embodiment of the present disclosure;

FIG. 4 is a diagram schematically illustrating the configuration in which a sensor is incorporated in each of secondary devices;

FIG. 5 is a diagram illustrating an example of arrangement of a power receiver, power receiving coil and sensor in the secondary device;

FIG. 6 is a block diagram illustrating another configuration example of the wireless charging system including a foreign object detector according to the embodiment of the present disclosure;

FIGS. 7A and 7B are diagrams illustrating examples in which there are foreign objects that generate an eddy current at different locations;

FIG. 8 is a diagram illustrating an example of basic resonance circuits in power transmitting and receiving sections of power transmitter and receiver;

FIG. 9 is a diagram illustrating an example in which the resonance frequency on the power receiving side is changed to stop the wireless charging of the secondary device;

FIG. 10 is a diagram illustrating an example in which the resonance circuit on the power receiving side is opened to stop the wireless charging of the secondary device; and

FIG. 11 is a diagram illustrating an example in which the impedance on the power receiving side is changed to stop the wireless charging of the secondary device.

### DETAILED DESCRIPTION OF THE PREFERRED EMBODIMENT

A description will be given below of the embodiment of the present disclosure with reference to the accompanying drawings. It should be noted that the description will be given in the following order.

1. Basic configuration of the wireless charging system
2. Configuration example of the power transmitter
3. Configuration example of the power receiver
4. Another configuration example of the power receiver
5. Configuration example in which the secondary device is prevented from receiving power

### <1. Basic Configuration of the Wireless Charging System>

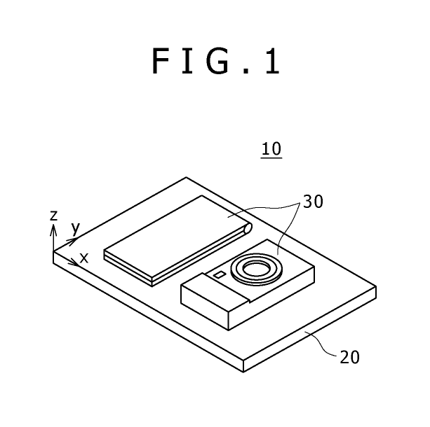

FIG. 1 is a diagram illustrating an overall configuration example of a wireless charging system according to an embodiment of the present disclosure.

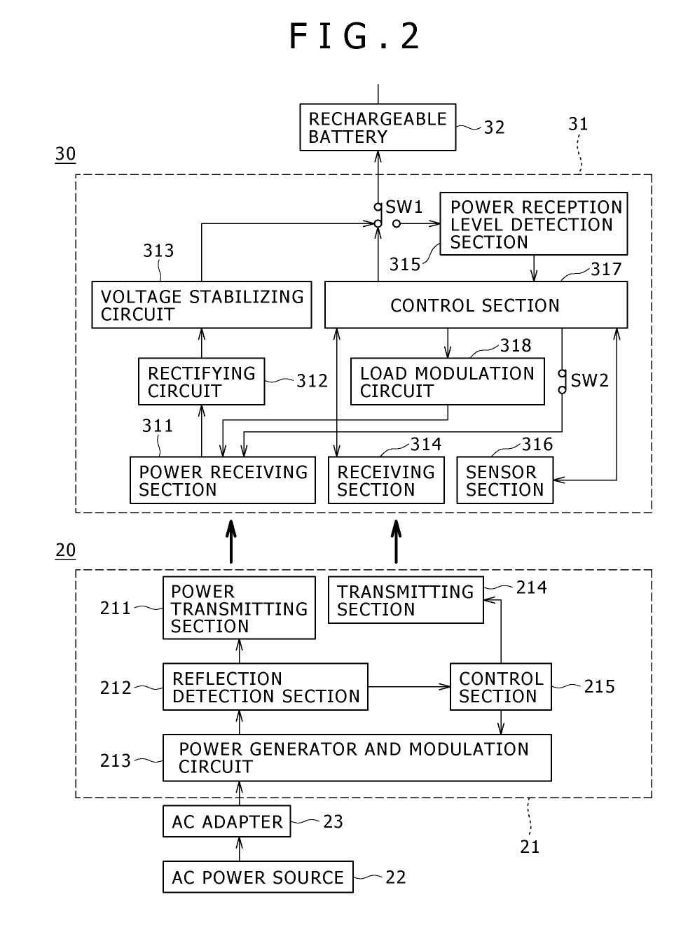

FIG. 2 is a block diagram illustrating a basic configuration example of the wireless charging system according to the embodiment of the present disclosure.

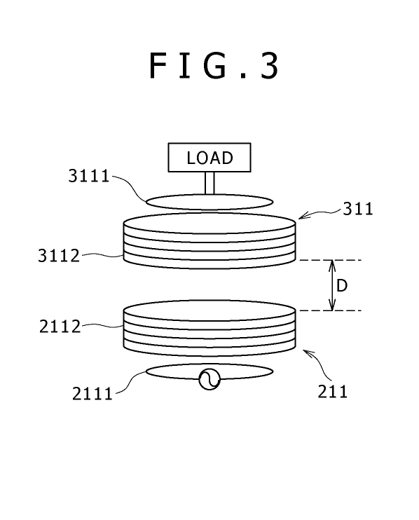

FIG. 3 is a diagram schematically illustrating an example of the relationship between coils on the power transmitting and receiving sides according to the embodiment of the present disclosure.

A wireless charging system 10 includes a primary device 20 and one or a plurality of secondary devices 30. The primary device 20 serves as a wireless charger including display and radio communication capabilities. Each of the secondary devices 30 is an electronic device (portable device) that includes a wireless power receiver.

In the present embodiment, the primary device 20 incorporating a power transmitter 21 made up, for example, of coils as illustrated in FIG. 2 specifically has a structure similar to a tray (mat) as illustrated in FIG. 1.

On the other hand, consumer electronics devices to be placed on the primary device 20 for wireless (noncontact) charging as illustrated in FIG. 1 are referred to as the secondary devices 30. Each of the secondary devices 30 incorporates a power receiver 31 made up, for example, of coils as illustrated in FIG. 2.

The plurality of secondary devices 30 can be placed on the primary device 20 for simultaneous or sequential supply of power to the plurality of secondary devices 30.

Time division charging method can be used as a means of sequential noncontact charging of a plurality of power receivers.

Japanese Patent Laid-Open No. 2009-268311 discloses a time division charging method as a means of sequential noncontact charging of a plurality of power receivers.

In this case, a power transmitter 21 assigns a time slot to one or two or more power receivers and selectively transmits power to the one or two or more power receivers in every time slot based on the assignment.

### <2. Configuration Example of the Power Transmitter>

The power transmitter 21 includes a power transmitting section 211, reflection detection section 212, power generator and modulation circuit 213, transmitting section 214 and control section 215 as illustrated in FIG. 2.

The power transmitter 21 is supplied with DC (Direct Current) power via an AC (Alternating Current) adapter 23 that converts AC power from an AC power source 22.

The power transmitting section 211 includes a resonance coil 2112 serving as a resonance element as illustrated in FIG. 3. Although also called a resonance coil, a resonance coil is referred to as such in the present embodiment. It should be noted that the power transmitting section 211 may include a power feeding coil 2111 serving as a power feeding element. On the other hand, the power transmitting section 211 may include a capacitor and inductor for the purpose of frequency correction or impedance matching.

A power feeding coil 2111 is formed, for example, with an air-core coil that is supplied with an AC current.

The resonance coil 2112 is formed with an air-core coil that is coupled with the power feeding coil 2111 by electromagnetic induction. A magnetic field resonance relationship is established when the self-resonance frequency of the resonance coil 2112 matches that of a resonance coil 3112 of the power receiver 31, thus allowing for highly efficient power transmission.

The reflection detection section 212 is capable of detecting transmitted and reflected power in power transmission and supplies the detection result to the control section 215.

The reflection detection section 212 supplies high frequency power, generated by the power generator, to the power transmitting section 211.

The power generator and modulation circuit 213 generates high frequency power for wireless power transmission.

High frequency power generated by the power generator and modulation circuit 213 is supplied to the power transmitting section 211 via the reflection detection section 212.

The power generator and modulation circuit 213 is capable of modulating information to be transmitted wirelessly via the transmitting section 214.

The transmitting section 214 can exchange control information and the detection result of transmitted and reflected power with the power receiver 31 through wireless communication. It should be noted, however, that if load modulation is used as described later, the transmitting section 214 can be modified so that the same section 214 is incapable of receiving information from the secondary side.

Bluetooth, RFID or other wireless technology can be used for wireless communication.

In response to the detection result from the reflection detection section 212, the control section 215 controls the power transmission to achieve high efficiency using the unshown impedance matching capability.

In other words, the control section 215 exercises control so that the self-resonance frequency of the resonance coil 2112 roughly matches that of the resonance coil 3112 of the power receiver 31, thus establishing a magnetic field resonance relationship and allowing for highly efficient power transmission.

In response to the detection result from the reflection detection section 212, the control section 215 acknowledges that, thanks, for example, to load modulation by the power receiver 31 in this condition, an anomaly such as temperature rise or presence of a foreign object has been reported to exist between the primary device 20 and secondary device 30. Then, the control section 215 exercises control so that the power transmission to the secondary device 30 in question is stopped.

In this case, the control section 215 exercises control so that power is transmitted to the other secondary device 30. In the absence of any secondary device available to receive power, on the other hand, the control section 215 can stop the power transmission itself.

### <3. Configuration Example of the Power Receiver>

The power receiver 31 includes a power receiving section 311, rectifying circuit 312, voltage stabilizing circuit 313, receiving section 314, power reception level detection section 315, sensor section 316, control section 317, load modulation circuit 318 and switches SW1 and SW2.

The power receiver 31 is connected to a rechargeable battery (secondary battery) 32, i.e., the load of a mobile phone or other device.

The power receiving section 311 includes a resonance coil 3112 serving as a resonance element. It should be noted that the power receiving section 311 may include a power feeding coil 3111 serving as a power feeding element. On the other hand, the power receiving section 311 may include a capacitor and inductor for the purpose of frequency correction or impedance matching.

The power feeding coil 3111 is fed with an AC current from the resonance coil 3112 by electromagnetic induction.

The resonance coil 3112 is formed with an air-core coil that is coupled with the power feeding coil 3111 by electromagnetic induction. A magnetic field resonance relationship is established when the self-resonance frequency of the resonance coil 3112 matches that of the resonance coil 2112 of the power transmitting section 211 of the power transmitter 21, thus allowing for highly efficient power reception.

The rectifying circuit 312 rectifies the received AC power into DC power and supplies the DC power to the voltage stabilizing circuit 313.

The voltage stabilizing circuit 313 converts the DC power supplied from the rectifying circuit 312 into a DC voltage compatible with the specification of the destination electronic device and supplies the stabilized DC voltage to the rechargeable battery (load) 32.

The receiving section 314 receives control information transmitted wirelessly from the transmitting section 214 of the power transmitter 21 and information about the detection result of transmitted and reflected power, supplying these pieces of information to the control section 317.

The power reception level detection section 315 receives the output voltage of the voltage stabilizing circuit 313 that is selectively connected via the switch SW1, supplying the power reception level to the control section 317.

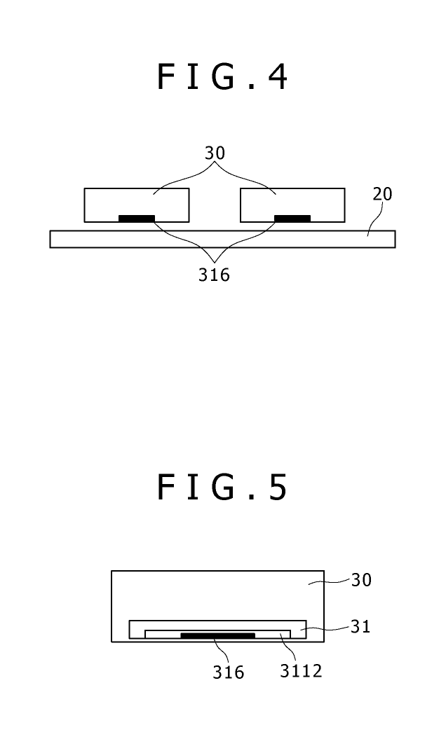

The sensor section 316 is incorporated in each of the secondary devices 30 as illustrated in FIG. 4 and detects any anomaly in the power transmission path between the power transmitter 21 and power receivers 31.

A temperature sensor or metal detection sensor is incorporated as the sensor section 316. The temperature sensor detects the temperature or rate of temperature rise. The metal detection sensor detects the presence or absence of a metal (foreign object) between the power transmitter and receiver.

Further, the sensor section 316 including a temperature sensor or metal detection sensor is provided not only on the same surface as the coil making up the power receiver 31 but also in this coil as illustrated in FIG. 5.

If the temperature sensor in one of the secondary devices detects that the temperature or rate of temperature rise exceeds a given threshold or if the metal detection sensor detects the presence of a metal between the power transmitter and receiver, the control section 317 exercises control to prevent the secondary device in question from receiving power.

For example, the control section 317 controls the load modulation circuit 318 so as to control the power status by modulating the load. Then, the same section 317 exercises control so that the power transmitter 21 can be informed of the detection of a foreign object by the reflection detection section 212 of the same transmitter 21.

### <4. Another Configuration Example of the Power Receiver>

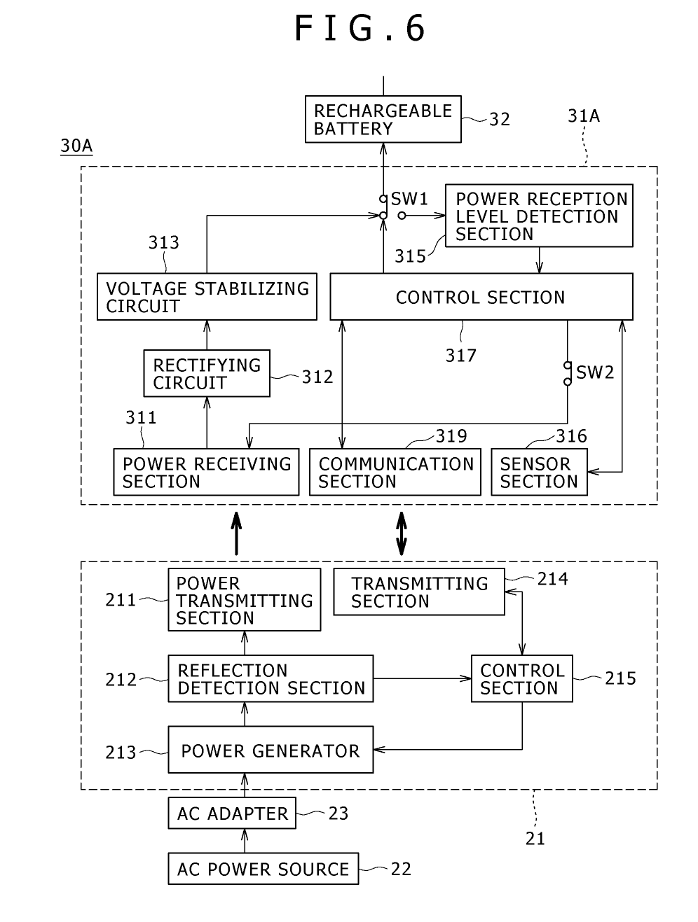

It should be noted that the receiving section 314 may be replaced by a communication section 319 as illustrated in FIG. 6 so that the control section 317 can inform the power transmitter 21 of the detection of an anomaly through wireless communication.

In this case, a load modulation circuit is not used.

As described above, in the present embodiment, each of the secondary devices 30 incorporates a temperature sensor adapted to detect the temperature or rate of temperature rise between the power transmitter and receiver or a metal detection sensor adapted to detect the presence or absence of a metal (foreign object) between the power transmitter and receiver. In this case, the sensor section 316, which is the temperature or metal detection sensor, is provided not only on the same surface as the coil making up the power receiver 31 but also in this coil.

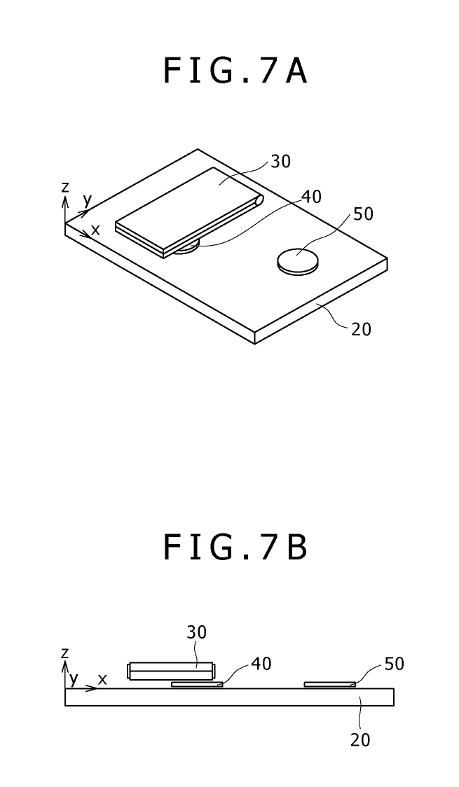

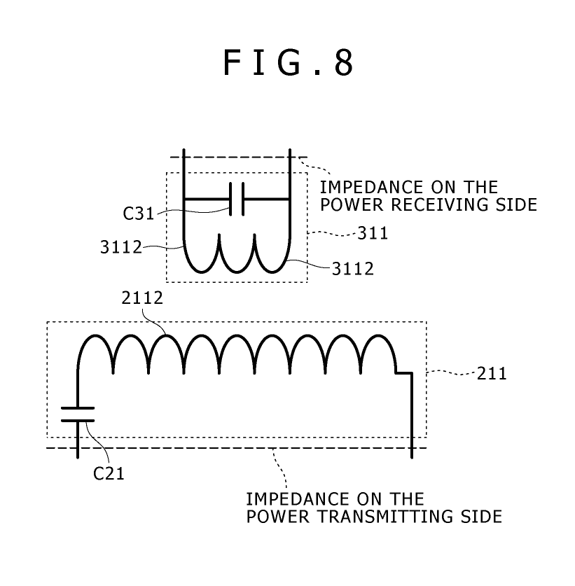

If, during wireless (noncontact) charging, as shown in FIGS. 7A and 7B, there is a foreign object (metal) 40 such as a coin or key in a space between the power transmitter 21 incorporating the primary device 20 and the power receiver 31 incorporating the secondary device 30, the following condition may occur.

That is, an eddy current is generated in the foreign object 40 because of its exposure to strong magnetic fields distributed between the power transmitter and receiver. This leads to a temperature rise of the foreign object 40, possibly resulting in continuous generation of heat if no countermeasure is taken.

In the present embodiment, for this reason, each of the secondary devices 30 is capable of informing the primary device, through communication or load modulation, whether the noncontact charging of the secondary device in question is conducted properly or improperly.

Then, if the temperature sensor in one of the secondary devices 30 detects that the temperature or rate of temperature rise exceeds a given threshold or if the metal detection sensor detects the presence of the metal (foreign object) 40 between the power transmitter and receiver, the secondary device 30 in question is prevented from receiving power.

On the other hand, the primary device 20 is capable of finding, through communication or load modulation, whether the wireless charging of the secondary devices 30 is conducted properly or improperly.

Then, if any of the secondary devices 30 is not properly charged through wireless charging, the primary device 20 is capable of stopping the supply of power to the secondary device in question and supplying power to the other secondary device 30. The primary device 20 is also capable of stopping the power transmission itself in the absence of any secondary device available to receive power.

This makes it possible to prevent heating of the foreign object 40 that has found its way between the power transmitter and receivers.

If a foreign object 50 is provided in a space on the primary device 20 but not between the power transmitter and any of the receivers (FIGS. 7A and 7B), the magnetic fields distributed in this space are significantly weaker than those between the power transmitter and receiver. Therefore, the temperature of the foreign object 50 will rise only slightly. As a result, it is unlikely that the foreign object may heat up when arranged as described above.

It should be noted that various types of sensors may be used as the temperature sensor. These include not only contact temperature sensors adapted to detect the temperature of a foreign object by being in contact therewith such as thermistors, thermocouples and polymer temperature sensing elements but also noncontact sensors using, for example, infrared radiation that can measure the temperature without being in direct contact with the foreign object because of various geometries of the secondary devices.

Further, each of the secondary devices 30 may incorporate not just one but a plurality of temperature or metal detection sensors. Still further, each of the secondary devices 30 can incorporate both a temperature sensor and a metal detection sensor.

Still further, a temperature or metal detection sensor can be incorporated not only in each of the secondary devices 30 but also in the primary device 20.

FIG. 2 or 6 illustrates a configuration example of a foreign object detection system according to the above embodiment when a plurality of power receivers are charged in a noncontact and time-divided manner.

As described above, FIG. 2 illustrates an example of the foreign object detection system using load modulation, and FIG. 6 illustrates an example of the foreign object detection system using communication.

In the example shown in FIG. 2, the change in the detection result of the reflection detection section 212 on the power transmitting side manifests itself as a result of load modulation on the power receiving side. This allows for the power transmitter 21 to find out about the status of the power receivers 31 without any information communicated from the power receivers 31.

Here, the switches SW1 and SW2 may include, for example, MOSFETs (Metal Oxide Semiconductor Field Effect Transistors) different in conductivity type from each other, but are not limited thereto.

<5. Configuration Example in Which the Secondary Device Is Prevented from Receiving Power>

In the present embodiment, the capability of preventing the secondary device from receiving power described above can be implemented by switching the switch SW2 shown in FIG. 2 or 6.

This example will be described with reference to the schematic diagrams shown in FIGS. 8, 9, 10 and 11.

FIG. 8 illustrates a configuration example of the power transmitting and receiving sections of the power transmitter and receiver.

In FIG. 8, the power transmitting section 211 includes the resonance coil 2112, i.e., a power transmitting coil, and a resonance capacitor C21 that is connected in series to the coil so that series resonance can be achieved at a given frequency.

On the other hand, the power receiving section 311 includes the resonance coil 3112, i.e., a power receiving coil, and a resonance capacitor C31 that is connected in parallel to the coil so that parallel resonance can be achieved at the same frequency as or one close to that for the power transmitting section 211. It should be noted that although a description will be given below using configuration examples as those described above, the power transmitting section need not necessarily be a series resonance circuit, and the power receiving section need not necessarily be a parallel resonance circuit. The power transmitting section may be a parallel resonance circuit, and the power receiving section may be a series resonance circuit.

On the other hand, we assume that the impedance on the power transmitting side and that on the power receiving side are matched respectively to those of the sections at the previous and following stages to a degree or better. Such a configuration allows for efficient wireless (noncontact) charging.

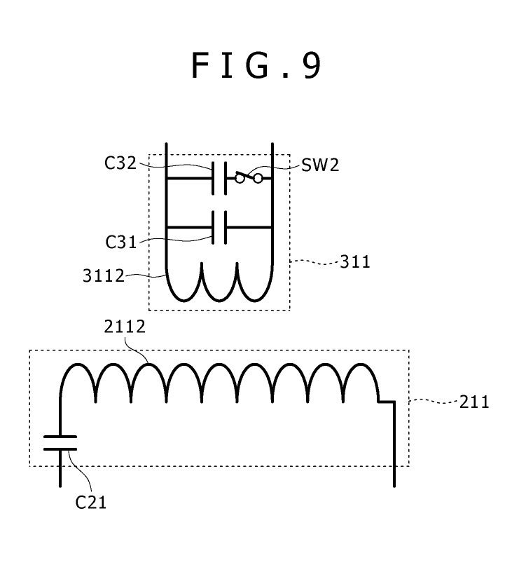

Therefore, if a resonance capacitor C32 having a sufficiently large electrostatic capacitance is added by connecting the capacitor using the switch SW2 as illustrated in FIG. 9, the resonance frequency on the power receiving side changes significantly, thus making it possible to stop the wireless (noncontact) charging. Alternatively, if the resonance capacitor C31 includes a plurality of capacitors, the resonance frequency on the power receiving side can be changed significantly by switching the switch in such a manner that some of the plurality of capacitors become unfunctional. This also makes it possible to stop the wireless (noncontact) charging.

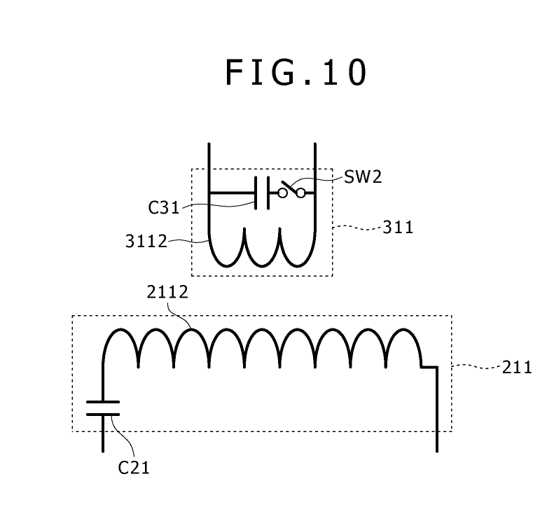

Still alternatively, resonance can be prevented from taking place in the power receiving section 311 by switching the switch in such a manner as to open the resonance area of the power receiving section 311 as illustrated in FIG. 10. This makes it possible to stop the noncontact charging.

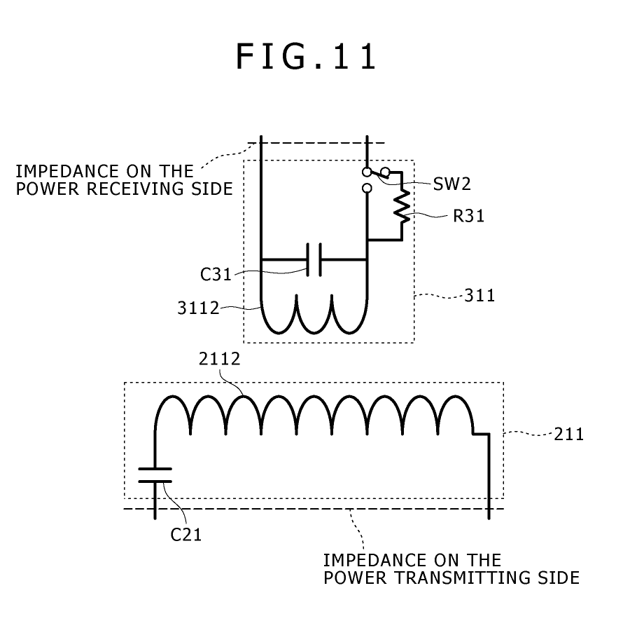

Still alternatively, the matching condition is not satisfied due to change in impedance on the power receiving side by switching the switch in such a manner as to add an excess resistance R31 to the power receiving section 311 as illustrated in FIG. 11. This makes it possible to stop the wireless (noncontact) charging.

As described above, the present embodiment provides the following advantageous effects.

In the case of noncontact charging from a single primary device to a plurality of secondary devices, if heating between the primary and secondary devices is prevented by providing temperature sensors in the primary device, an infinite number of such temperature sensors are used, probably resulting in an extremely high cost. Further, it is likely that the power feeding efficiency may degrade.

In the present embodiment, as many temperature or other sensors are provided only in the plurality of secondary devices as necessary rather than in the primary device, thus avoiding heating with a minimum number of sensors.

This provides significantly reduced cost as compared to related art, thus keeping the degradation of the power feeding efficiency to a minimum.

The present disclosure contains subject matter related to that disclosed in Japanese Priority Patent Application JP 2010-181246 filed in the Japan Patent Office on Aug. 13, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A wireless charging system, comprising:
a primary device that includes a power transmitter adapted to transmit power wirelessly; and
a secondary device that includes a power receiver adapted to receive power transmitted wirelessly from the power transmitter, wherein
the secondary device also includes a sensor adapted to detect any anomaly in the power transmission path between the power transmitter and receiver.

2. The wireless charging system of claim 1, wherein
each of the primary and secondary devices includes a control section adapted to prevent the transmission and reception of power between the power transmitter and receiver.

3. The wireless charging system of claim 2, wherein
the primary device includes a control section adapted to exercise control so that power is supplied simultaneously or sequentially to the plurality of secondary devices each including the power receiver.

4. The wireless charging system of claim 3, wherein
the primary device includes a control section capable of stopping, in the event of detection of an anomaly related to the power transmission and reception by the sensor in the secondary device, the supply of power to the secondary device in which the anomaly has been detected and also capable of stopping the power transmission itself in the absence of any secondary device available to receive power.

5. The wireless charging system of claim 4, wherein
the secondary device includes a control section adapted to exercise control, in the event of detection of an anomaly related to the power transmission and reception by the sensor in the secondary device, so that the secondary device is prevented from receiving power.

6. The wireless charging system of claim 5, wherein
the control section of the secondary device is capable of informing the primary device, through communication or load modulation, whether the noncontact charging of the secondary device is conducted properly or improperly.

7. The wireless charging system of claim 6, wherein
the control section of the primary device is capable of finding, through the communication or load modulation, whether the noncontact charging of the secondary device is conducted properly or improperly.

8. The wireless charging system of claim 1, wherein
the sensor is provided not only on the same surface as the coil making up the power receiver but also in this coil.

9. The wireless charging system of claim 1, wherein
a sensor is provided not only in the secondary device but also in the primary device to detect any anomaly in the power transmission path between the power transmitter and receiver.

10. The wireless charging system of claim 1, wherein
the sensor is a temperature sensor adapted to detect the temperature or rate of temperature rise or a metal detection sensor adapted to detect the presence or absence of a foreign object between the power transmitter and receiver.

11. The wireless charging system of claim 10, wherein
the sensor is a contact or noncontact sensor.
